(19) United States
(12) Patent Application Publication
(10) Pub. No.: US 2022/0080673 A1
(43) Pub. Date: Mar. 17, 2022

(54) PRODUCING A SHELL LAYER IN ADDITIVE MANUFACTURING

(71) Applicant: Hewlett-Packard Development Company, L.P., Spring, TX (US)

(72) Inventors: Salvador SANCHEZ RIBES, Sant Cugat del Vallès (ES); Alex CARRUESCO LLORENS, Sant Cugat del Vallès (ES); Leticia RUBIO CASTILLO, Sant Cugat del Vallès (ES); Sergio GONZALEZ MARTIN, Sant Cugat del Vallès (ES)

(21) Appl. No.: 17/423,804

(22) PCT Filed: Apr. 29, 2019
(86) PCT No.: PCT/US2019/029600

§ 371 Date: Jul. 16, 2021

(51) Int. Cl. B29C 64/393; B33Y 30/00; B33Y 50/02; B29C 64/165; B33Y 10/00

(52) U.S. Cl. CPC B29C 64/393; B33Y 30/00; B33Y 10/00; B29C 64/165; B33Y 50/02

(57) ABSTRACT

A method of producing a shell layer of an output item in an additive manufacturing process comprises forming a first laterally intermittent shell layer (74) and at least one subsequent laterally intermittent shell layer (76), wherein each laterally intermittent shell layer (74,76) at least partially overlaps and joins with at least one of the other laterally intermittent shell layers.

Additive manufacturing or 3D printing technologies produce output items by adding successive layers of material, or build material, that are fused or solidified to create a final shape. Powder-bed fusion 3D printing technologies benefit from a cooling down period to reduce the likelihood of deformation of an output item.

There is provided an apparatus and method as set forth in the appended claims. Other features will be apparent from the dependent claims, and the description which follows.

### BRIEF DESCRIPTION OF THE DRAWINGS

FIG. 1 is a schematic perspective view of an output item in an additive manufacturing apparatus, the output item having a shell layer, according to one example;

FIG. 2 is a partial schematic perspective view of the additive manufacturing apparatus, showing printheads thereof, according to one example;

FIG. 3 is a schematic block diagram of a 3D printing apparatus, according to one example;

FIG. 4 is a schematic flow chart showing how instructions are used to control a processor of the 3D printing apparatus of FIG. 3, according to one example;

FIG. 5 shows a schematic partial perspective view of a plurality of laterally intermittent shell layers, according to one example;

FIG. 6 shows a schematic partial side view of the laterally intermittent shell layers of FIG. 5, according to one example;

FIG. 7 shows a schematic partial perspective view of a plurality of laterally intermittent shell layers having a different configuration to FIG. 5, according to another example;

FIG. 8 shows a schematic partial side view of the laterally intermittent shell layers of FIG. 7, according to the other example; and

FIG. 9 is a schematic flow diagram of a method for producing an output item with a 3D printing apparatus, according to one example.

### DETAILED DESCRIPTION

Powder-bed fusion 3D printing technologies can use the combined effect of fusing enhancers and other agents (detailing, coloring, etc.) deposited on a thermoplastic powder bed to delimit regions that will be melted by an IR fusing radiation source for each layer to form a 3D output item. In High Speed Sintering an inkjet printhead deposits a black infrared radiation absorbing ink onto a bed of thermoplastic powder, outlining a desired shape. An infrared lamp then heats the powder, causing the particles to fuse.

Some 3D printing technologies, especially the ones selectively melting plastic powder, allow the final printed output item to cool down slowly to avoid deformations on the parts due to differential cool down (thermal effects).

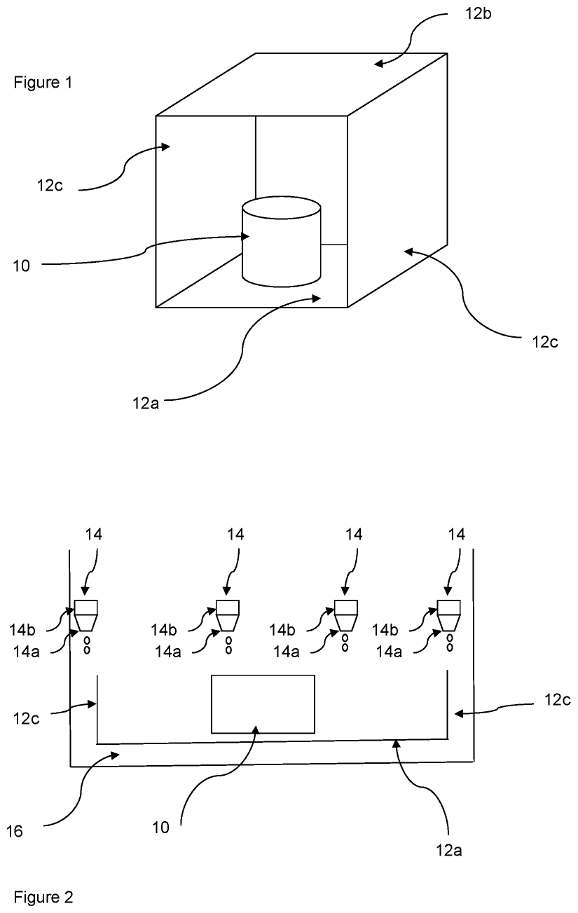

In order to allow an output item to be removed from a 3D printing apparatus before cooling has finished it can be built with an envelope, or shell, around it, as shown in FIG. 1, which shows an output item 10 encased in a shell having a lower section 12a, an upper section 12b and sidewalls 12c, one closest to the viewer not being shown in FIG. 1 to aid clarity. The shell encases the output item and unfused powder that is surrounding the output item. The unfused plastic powder has a given thermal conductivity, which generally is low, which results in relatively long cooling times (i.e. the time it takes for fused portions to cool below an acceptable handling temperature). The shell should form an enclosure, which may be open at an upper end, to ensure that unfused powder does not escape. The unfused powder physically supports the output item.

FIG. 2 shows schematically the output item 10 and the lower section 12a and lower parts of the sidewalls 12c of the shell being formed in a build area 16 of a 3D printing apparatus. The unfused plastic powder has been omitted for clarity. Printheads 14 (not all printheads 14 are shown to assist clarity) move across the build area 16, into and out of the picture plane with reference to FIG. 2. The printheads 14 expel drops to cause plastic powder in the build area 16 to fuse. The lower section 12a is a large planar surface and the page-wide array of printheads 14 is forced to print at a high duty cycle to produce the lower section 12a. This can cause nozzles 14a of the printheads 14 to overheat due to the repeated use of nozzle resistors 14b, which heat up to expel drops of print fluid. A lower duty cycle may result in better long-term reliability of the printheads 14.

The lower section 12a and the upper section 12b may be approximately 2 mm thick. There may be a separation of approximately 5 mm between edges of the build item 10 and the shell 12a, 12b, 12c.

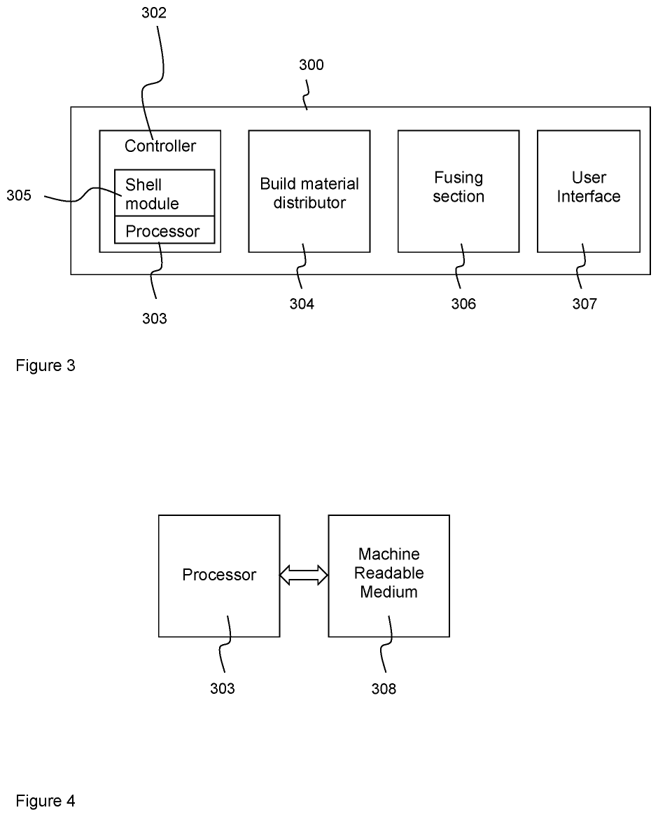

FIG. 3 shows a schematic block diagram of a 3D printing apparatus 300 incorporating a controller 302, a build material distributor 304, a shell module 305 and a fusing section 306. The 3D printing apparatus is in this example is a powder-bed fusion technology apparatus in which a processor 303 of the controller 302 uses instructions sent to the shell module 305 to control the build material distributor 304 to distribute build material, which is then selectively fused by the fusing section 306. The instructions are based on data that define a shape to be created in the apparatus 300.

FIG. 4 is a flow chart showing instructions from a machine readable medium 308 being supplied to the processor 303 for execution by the processor 303 to control the 3D printing apparatus 300.

In order to reduce the duty cycle of the printhead laterally intermittent shell layers are produced, wherein each laterally intermittent shell layer at least partially overlaps with and joins with at least one other laterally intermittent shell layer.

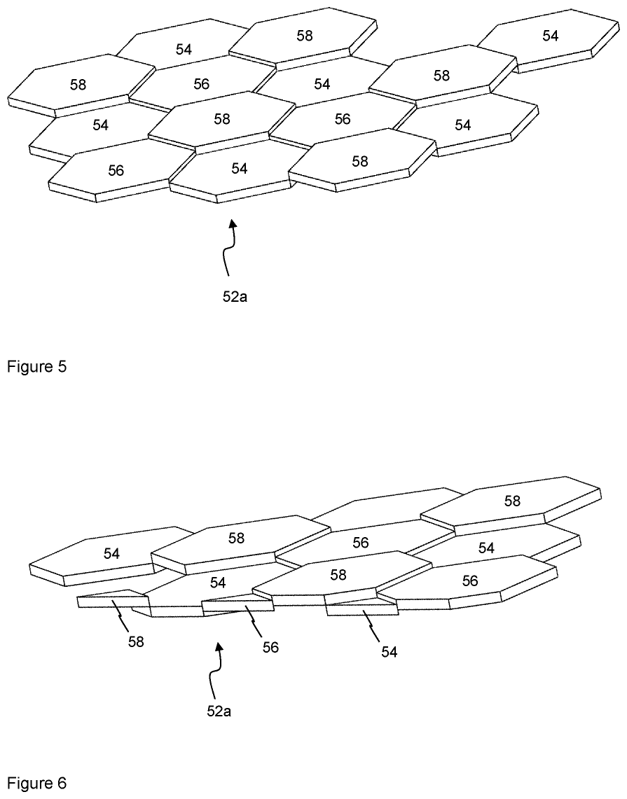

FIG. 5 shows a partial lower section 52a of a shell that extends across a complete build area of a 3D printing apparatus, but is shown only incompletely in FIG. 5 for better clarity. FIG. 6 shows the same layer, but in even more detail. The lower section 52a of the shell is made up of a plurality of intermittent shell layers. A first intermittent shell layer 54 comprises a plurality of spaced hexagons at a lowest level. A subsequent, second, intermittent shell layer 56 comprises a plurality of spaced hexagons at a second level that overlaps in a direction of increasing build depth by about 50% with the first intermittent shell layer 54. A subsequent, third, intermittent shell layer 58 comprises a plurality of spaced hexagons at a third level that overlaps in a direction of increasing build depth by about 50% with the second intermittent shell layer 56. In this way there is substantially little or no overlap between the first intermittent shell layer 54 and third intermittent shell layer 58. Approximately 33% of the plan area lower section 52a of the shell is made up of the first intermittent shell layer 54, with approximately 33% of the plan area being made up of the second intermittent shell layer 56 and approximately 33% of the plan area being made up of the third intermittent shell layer 58.

In producing the lower 50% of the first intermittent shell layer 54 the duty cycle of the printhead (taking the example of a powder-bed fusion 3D printing apparatus) will be approximately 33%, on the basis that approximately 33% of the plan area of the lower section 52a plan area of the shell is made up of the first intermittent shell layer 54.

The upper 50% of the first intermittent shell layer 54 coincides laterally with the lower 50% of the second intermittent shell layer 56, meaning that for the production of this section the printhead duty cycle will be approximately 66%, on the basis that approximately 66% of the plan area lower section 52a of the shell is made up of the first intermittent shell layer 54 or the second intermittent shell layer 56.

The upper 50% of the second intermittent shell layer 56 coincides laterally with the lower 50% of the third intermittent shell layer 58, meaning that for the production of this section the printhead duty cycle will be approximately 66%, on the basis that approximately 66% of the plan area lower section 52a of the shell is made up of the second intermittent shell layer 56 or the third intermittent shell layer 58.

In producing the upper 50% of the third intermittent shell layer 58 the duty cycle of the printhead will be approximately 33%, on the basis that approximately 33% of the plan area of the lower section 52a of the shell is made up of the third intermittent shell layer 58.

In producing the lower section 52a of the shell, the overall duty cycle will be approximately 50% based on two sections at 33% duty cycle and two sections at 66% duty cycle. Thus there is a considerable reduction in duty cycle compared to the 100% duty cycle referred to above for a non-intermittent lower section 12a, as shown in FIG. 1. The first to third intermittent shell layers 54-58 may be approximately 2 mm thick, giving and overlap of 1 mm and a depth of 4 mm for the combination of the first to third intermittent shell layers 54-58.

The same considerations apply to the production of an upper section of the shell, which is the same shape as the lower section 52a. In the drawings, the upper section is also represented by FIGS. 5 and 6, with the same reference numerals.

Other amounts of overlap between intermittent shell layers are possible, for example a smaller amount of overlap is an option. Similarly, it could be envisaged that two intermittent shell layers are used.

As can be seen in FIGS. 5 and 6 the intermittent shell layers 54, 56, 58 are made up of tessellating shapes, which in this example are hexagons, although other shapes, which may also tessellate, are possible. Each hexagon is surrounded (except at the edges) by hexagons from other intermittent shell layers. In this example, no element of an intermittent shell layer is adjacent to another element from the same intermittent shell layer. All of the elements of the intermittent shell layers 54, 56, 58 join to the other adjacent elements that they overlap.

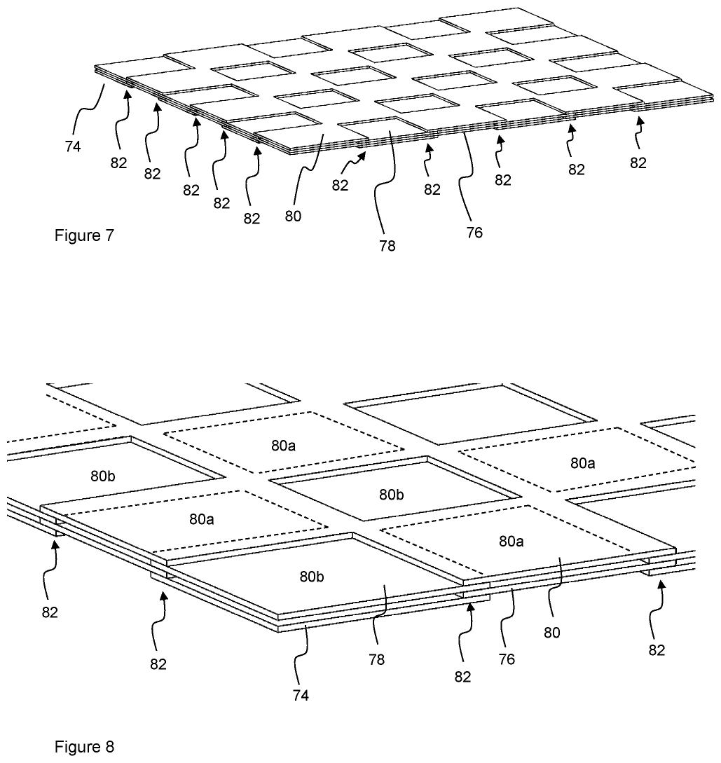

Another example of a lower or upper section of a shell is shown in FIGS. 7 and 8. In those Figures four layers are shown: a first intermittent shell layer 74; a second, subsequent, intermittent layer 76; a third, subsequent intermittent shell layer 78; and a fourth, subsequent, intermittent shell layer 80.

The first and third intermittent shell layers 74 and 78 have the same shape as each other with square voids in the same lateral locations, albeit separated in the build direction with the second layer 76 between them. The first and third intermittent shell layers 74 and 78 have a grid shape consisting of adjoining larger square shapes (80a in FIG. 8) with merged corner sections thereof with smaller square voids 80b between. The voids 80b will contain build power that has not been treated to fuse, but due to thermal bleed from the adjacent fused material, either to the sides and above/below will still fuse to some extent.

The shape of the first and third intermittent shell layers 74 and 78 is shown by the dashed lines in FIG. 8. At edges of the lower/upper section of the shell, the smaller voids 80b mentioned above may be rectangular, due to a lack of adjoining larger square shapes 80a around the edge. Furthermore, some material has been missed from the edges in FIGS. 7 and 8 to assist clarity of the Figures.

The second and fourth intermittent shell layers 76 and 80 have the same shape as each other, being overlaid versions of each other. The second and fourth intermittent shell layers 76 and 80 are offset from the first and third intermittent shell layers 74 and 78 by half a “wavelength” of the pattern repeat. Given that the squares of material (with merged corners) 80a in a given intermittent shell layer are larger than the square voids 80b, there is some overlap between neighbouring layers, as shown by the arrows 82 in FIGS. 7 and 8. The overlap provides structural integrity to the lower/upper section of the shell.

The repeating pattern of the intermittent first to fourth intermittent shell layers 74-80 is the same for each layer, although there may be some minor differences around the edges, as mentioned above.

In producing the first to fourth intermittent shell layers 74-80 the duty cycle of the printhead of the 3D printing apparatus is reduced to approximately 60%, depending on the size of the overlap at the regions 82.

The example shown in FIGS. 7 and 8 relies on the fact that an untreated layer between two heated layers will still fuse, because the heat captured by the surrounding printed areas can be sufficient to fuse the non-printed/untreated areas. Fusing of the non-printed areas can be achieved by designing a printing pattern depending on the thermal behaviour of a given 3D printing apparatus, for example by considering how much thermal bleed occurs for a given apparatus. The material fused by thermal bleed may not reach the same mechanical properties as the printed areas, but strength is good enough to fulfil the purposes of the shell, which is mainly keeping the parts of the output item and the unfused build powder together during the cooling process outside the 3D printing apparatus.

The example of FIGS. 7 and 8 provides a checkerboard shape, but other shapes can be used.

Both of the examples above provide a method of producing an upper and/or lower shell layer of an output item in an additive manufacturing or 3D printing process with a reduced duty cycle for a printhead in a powder-bed fusion process. Similarly, the duty cycle of a laser in a SLS or HSS system in an additive manufacturing or 3D printing process can also be reduced. Both examples result in a shell layer of an output item comprising a plurality of intermittent shell layers that is laterally complete to prevent unfused or non-solidified build powder passing through the shell layer.

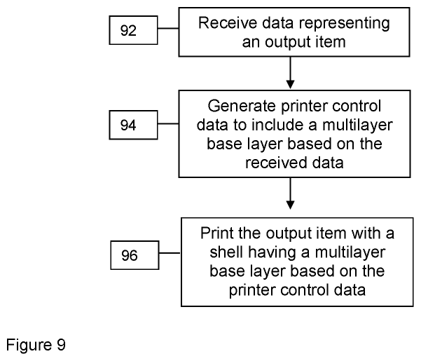

A method of producing a lower and/or upper section of a shell for an output item in an additive manufacturing or 3D printing process may include the actions shown in FIG. 9 of receiving data representing an output item including a shell layer (box 92), generating printer control data based on the received data (box 94) and printing the output item based on the printer control data (box 96).

Box 94 may include processing the data representing the output item to determine if lower and/or upper layers of a shell of the output item are to be produced using a full duty cycle method as described above, if so, the method may include replacing that data with data corresponding to a shell layer of an output item comprising a plurality of intermittent shell layers, as described above. The shell layer comprising a plurality of intermittent shell layers may be referred to as a multilayer base or multilayer shell section. This feature allows data representing an output item to be agnostic as to a type of shell layer and for the shell layer to be output in a form comprising a plurality of intermittent shell layers.

FIG. 9 may be implemented in a ‘pre-print’ software application stored for example on the machine-readable medium 308 shown in FIG. 3. The application may provide functionality for a number of objects for printing by the 3D printing apparatus to be selected and for the objects to have a container or shell built around them—the size of the container is based on the size of the objects selected. The container base (and possibly the lid) is designed to have the multilayer base 52a described above. This ‘print job’ may then be sent to a printer which would print the whole print job (i.e. container and objects).

An alternative implementation of FIG. 9 provides a user interface 307 of the 3D printing apparatus offering functionality to allow a number of objects to be selected for printing and those objects are then be formed in a container or shell as described above. The size of the container is based on the size of the objects selected. The container base (and possibly the lid) is designed to have the multilayer base 52a described above. This ‘print job’ may then be printed by the 3D printing apparatus, which would print the whole print job (i.e. container and objects)

The examples described above allow 3D printers to print a thin envelope/shell around all parts of an output item, which shell can hold the parts together with the surrounding non-fused powder. This allows the printed output item to be moved without affecting the part quality of the printed parts of the output item. The shell generation takes into account the durability of the 3D printing apparatus, so that the shell is printed in a way that reduces the stress on the 3D printing apparatus when printing large areas.

Thanks to the above intermittent shell layers, a lower duty cycle of the 3D printing apparatus, printheads, lasers etc is achieved.

Keeping a low duty cycle allows: maintaining the performance of the printheads/printing system in powder-bed fusion technologies and extending the life of the printing apparatus; reducing the printing time of the layers in Selective Laser Sintering technologies; and furthermore, the above printing patterns for generating the intermittent shell layers reduce the consumables used to print them (e.g. ink in the case of powder-bed fusion, energy in the case of laser-based systems, etc.) because a wide area is fused while reusing the heat of the surrounding fused regions.

All of the features disclosed in this specification (including any accompanying claims, abstract and drawings), and/or all of the parts of any method or process so disclosed, may be combined in any combination, except combinations where at least some of such features and/or parts are mutually exclusive.

1. A method of producing a shell layer of an output item in an additive manufacturing process, the method comprising:
forming a first laterally intermittent shell layer and at least one subsequent laterally intermittent shell layer, wherein each laterally intermittent shell layer at least partially overlaps and joins with at least one of the other laterally intermittent shell layers.

2. The method of claim 1, wherein the laterally intermittent layers comprise spaced polygonal shapes.

3. The method of claim 1, wherein the first laterally intermittent shell layer and the subsequent laterally intermittent layers together form a laterally complete shell layer.

4. The method of claim 1, wherein the overlap between intermittent shell layers is a vertical overlap with respect to a direction of increasing build depth of the output item.

5. The method of claim 4, wherein the first and subsequent intermittent shell layers are formed of laterally tessellating shapes.

6. The method of claim 1, wherein the overlap between intermittent shell layers is a horizontal overlap with respect to a direction of increasing build depth of the output item.

7. The method of claim 6, in which wherein one of the subsequent laterally intermittent layers has the same pattern as the first laterally intermittent shell layer or another of the subsequent laterally intermittent shell layers.

8. The method of claim 7, wherein a first laterally intermittent shell layer and at least one subsequent laterally intermittent shell layer.

9. A non-transitory machine-readable storage medium comprising instructions executable by a processor to control an additive manufacturing system to form respective patterns of fused build material derived from data representing a layer of a three-dimensional object to be generated, the instructions to cause the processor to:
form a first laterally intermittent shell layer, and
form at least one subsequent laterally intermittent shell layer, wherein each laterally intermittent shell layer at least partially overlaps and joins with at least one of the other laterally intermittent shell layers.

10. The non-transitory medium as claimed in claim 9, wherein the instructions cause the processor to determine if data representing a shell having a substantially continuous lateral shell layer is present in the data representing a slice of a three-dimensional object to be generated, and if so, replacing the data with data for the first and at least one subsequent laterally intermittent shell layers.

11. An apparatus for generating a three-dimensional object, the apparatus comprising:
a build material distributor to distribute build material;
a fusing section to selectively fuse distributed build material; and
a controller to control the build material distributor and the fusing section to form respective patterns of fused build material derived from data representing a slice of a three-dimensional object to be generated,
wherein the controller is further to control the build material distributor and the fusing section to selectively deliver and fuse a layer of build material in respective patterns representing a slice of a shell within which the three-dimensional object is to be generated, and
wherein the controller is to control formation of a first laterally intermittent shell layer, and to control formation of at least one subsequent laterally intermittent shell layer, wherein each laterally intermittent shell layer at least partially overlaps and joins with at least one of the other laterally intermittent shell layers.

12. The apparatus as claimed in claim 11, wherein the controller is to receive the data representing slices of the three-dimensional object to be generated and to determine if the data represents a shell having a substantially continuous lateral shell layer, and if so, replacing the data with the data representing the first and at least one subsequent laterally intermittent shell layers.
